(19) United States
(12) Patent Application Publication
(10) Pub. No.: US 2024/0108043 A1
(43) Pub. Date: Apr. 4, 2024

(54) NONNUTRITIVE SWEETENER COMPOSITIONS, METHODS OF MANUFACTURE AND USES THEREOF

(71) Applicants: Andrew Barninger, Tampa, FL (US); Lucas Scheider, Homer, AK (US)

(72) Inventors: Andrew Barninger, Tampa, FL (US); Lucas Scheider, Homer, AK (US)

(21) Appl. No.: 18/459,166

(22) Filed: Aug. 31, 2023

Related U.S. Application Data
(60) Provisional application No. 63/374,238, filed on Aug. 31, 2022.

(51) Int. Cl. A23L 27/30; A23L 27/00; A23L 33/22

(52) U.S. Cl. CPC A23L 27/36; A23L 27/33; A23L 27/84; A23L 33/22

(57) ABSTRACT

A nonnutritive sweetener composition including allulose, erythritol, and stevia leaf extract in the form of diterpene glycosides; specifically stevioside, rebaudioside A and/or M. The nonnutritive sweetener combines these sweeteners with a starch or polysaccharide that does not readily break down into monosaccharides. The allulose may be either one of d-psicose and d-allulose. The soluble fiber may be either soluble corn fiber and/or soluble tapioca fiber. The stevia extract is a steviol glycoside including at least one of rebaudioside A, rebaudioside B, rebaudioside M, and steviosides.

### CROSS-REFERENCE TO RELATED APPLICATIONS

This application claims priority to U.S. Provisional Application Ser. No. 63/374,238 filed on Aug. 31, 2022, the contents of which are hereby incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable.

### BACKGROUND OF THE INVENTION

### Field of the Invention

The present invention relates to the field of nonnutritive ingredients in food and beverages to replace caloric nutritive ingredients in foods and beverages and the process of preparing the nonnutritive ingredient, more specifically to be used as a nonnutritive sweetener. More particularly, the invention relates to a nonnutritive sweetener composition having improved physical properties.

### Description of the Related Art

Obesity is one of the primary causes of comorbidities such as heart disease, type two diabetes, non-alcoholic fatty liver disease, and metabolic syndrome, which are linked to early mortality. The exponential rise in obesity over the last 50 years is closely associated with excess caloric intake due to the widespread use of highly palatable sweeteners such as high fructose corn syrup, sucrose or cane sugar, agave nectar, honey, rice syrup and concentrated fruit sources such as fruit pastes or dried/dehydrated fruit. Fruit pastes or dried/dehydrated fruits have been used to replace sweeteners such as high fructose corn syrup as a more “natural alternative.” Although, concentrated fruit sources result in the same negative metabolic impact as the other sweeteners. The above mentioned sweeteners are referred to herein as “common sweeteners.”

Many packaged goods use common sweeteners for purposes such as flavor enhancement, sweetening, bulking, preservation, coloring, thickening, anti-coagulation (preventing proteins from solidifying), and to reduce water activity. Although, the concern with these common sweeteners is that they are highly palatable, which may lead to excess calorie intake. Often, common sweeteners are used because they are inexpensive for manufacturing and produce repeatable, desired results.

Common sweeteners result in a rise in blood glucose and blood insulin, which is commonly associated with comorbidities such obesity, type two diabetes, non-alcoholic fatty liver disease, and heart disease, collectively called metabolic syndrome. A consistent rise in blood sugar and blood insulin has the potential to store consumed energy as body fat when eaten in excess; especially in those suffering from insulin resistance.

Fruit pastes or dried/dehydrated fruits have been used to replace sweeteners such as high fructose corn syrup as a more “natural alternative,” although, concentrated fruit sources result in the same negative metabolic impact as the other sweeteners. From here on, the previously mentioned sweeteners will be known as common sweeteners. Many packaged goods use common sweeteners for purposes such as a flavor enhancement, sweetening, bulking, preservation, coloring, thickening, anti-coagulation (preventing proteins from solidifying), and to reduce water activity. Although, the concern with these common sweeteners is that they are highly palatable, which may lead to excess calorie intake. Often, common sweeteners are used because they are inexpensive for manufacturing and produce repeatable, desired results. Common sweeteners result in a rise in blood glucose and blood insulin, which is often associated with comorbidities such obesity, type two diabetes, non-alcoholic fatty liver disease, and heart disease, collectively called metabolic syndrome. A consistent rise in blood sugar and blood insulin has the potential to store consumed energy as body fat when eaten in excess; especially in those suffering from insulin resistance.

One such sweetener is sucrose. Sucrose is the most common sweetener and contains 50% glucose and 50% fructose. In cooking and baking it is used to add texture, sweetness, retain water (tenderizer), suspend other constituents within a solution, affect the browning of foods, act as a preservative and to add flavor & color. Glucose and fructose have the same molecular formula but are structural isomers meaning their three-dimensional structure are different. In sucrose, glucose and fructose are bound together by a 1-2 alpha glycosidic bond between carbon-one on glucose and carbon-two on fructose. Glucose possesses a sweetness equal to sucrose whereas the sweetness of fructose alone is approximately 1.7 times the intensity of sucrose.

The following is a brief review of allulose, erythritol, soluble corn fiber, and salt; the primary ingredients found in the designed nonnutritive sweetener.

Allulose. D-allulose (including d-psicose, d-allulose, D-ribo-2-hexulose) is a monosaccharide with the chemical nomenclature of C6H12O6 and is a C-3 epimer of D-fructose. D-allulose is naturally occurring in foods such as cane and beet molasses, jackfruit, figs, and raisins. Although, it can be obtained during the hydrolysis of sucrose, during the isomerization of D-glucose with D-Xylose Isomerase to D-fructose then to D-allulose via D-Tagatose 3-epimerase and/or due to the action of Ketose 3-epimerase on D-Fructose. D-allulose has been of interest to researchers for the past two decades because of low metabolic impact on rats and humans.

Rodent and human data for the use of allulose as an adjuvant for acute glycemic control, improved hepatic function and weight maintenance is consistent among the clinical trials. However, more research needs to be conducted in healthy and diseased human models to demonstrate if chronic allulose consumption can improve weight status, BMI, and body fat. Furthermore, human trials investigating chronic allulose consumption should seek to understand the mechanism of action by which allulose works to improve glycemic control and improved hepatic function. Additionally, this research should explore allulose's effects on biochemical markers of glucose control through its insulin sensitizing, fat oxidation, and gut hormone effects to better understand how it may be of use to mitigate the obesity and disease epidemic. Lastly, safety trials on allulose consumption above 15 grams per day need to be explored to understand if it is a suitable replacement for sugar and its analogs in SSB and CPG because the average daily added sugar intake in adults over the age of 20 years is 85 grams per day.

Erythritol. Erythritol (Erythrit, Meso-erythritol, or Tetrahydroxybutane) with the systematic name (2R,3S)-Butan-1,2,3,4-tetrol is a polyol or subset of sugar alcohols formed during the hydrolyzation of a ketone or aldehyde groups from glucose or fructose via lactic acid producing bacteria or yeast. The biological effectiveness of erythritol is that it is non-caloric, non-glycemic, non-carcinogenic, has a high digestive tolerance, scavenges free radicals, possess endothelial protective properties, and decreases absorption of fructose.

Erythritol is naturally found in fruits and vegetables and is 60-70% as sweet as sucrose. It is produced via fermentation of glucose. Interestingly, erythritol is not fermented within human digestion. Approximately 90% of erythritol is excreted through urine with its molecular structure unchanged. As the molecular structure of erythritol is unchanged, it has little influence on blood glucose or insulin. Erythritol is safe for those with glucose control issues such as insulin resistance or diabetes and may possess free-radical scavenging properties.

Erythritol has no effect on blood glucose insulin diabetic human subjects after daily administration of 20 g erythritol for 14 days. Comparatively these results are similar to rodents with induced diabetes. While erythritol does not directly affect insulin levels it has potential benefits that may lower risk factors of diabetes mellitus. Recent data from rodent studies have shown erythritol exerts antihyperglycemic properties. These effects include reducing the absorption of glucose in the small intestine, improved glucose uptake in the muscles through GLUT-4 expression, and improved glycogen storage (Chukwuma et al., 2017). Furthermore, it has also been shown in lean and obese human subjects that erythritol upregulates the release of CCK and GLP-1. These peptides are responsible for prolonged gastric emptying, therefore signaling early meal termination. Due to the current data erythritol may be a useful supplement for hyperglycemia in diabetic patients, particularly patients with type-two diabetes.

Both human and rodent studies have shown improvements in endothelial function, specifically reduction of central aortic stiffness. Relating to this occurrence, recent rodent studies have also validated erythritol having antioxidant properties. High performance chromatography has displayed erythritol reacting with hydroxyl radicals resulting in the formation of erythrose and erythrulose.

While satisfactory as a nonnutritive sweetener erythritol, and most sugar alcohols, or polyols, are not able to fully mimic the desired taste characteristics or functional properties such as browning. Lastly, they cannot be used in high quantities because of low gastrointestinal tolerance. For example, mannitol in doses greater than 20 grams can cause laxative affects in a single bolus and is often used as an osmotic laxative binding to water in the small intestine. This affect can be seen in doses of sorbitol at 0.24 g/kg or 0.17 g/kg in women and men, respectively. Furthermore, doses of 30-40 grams of lactitol significantly (p<0.01) increased incidence of gastrointestinal distress compared to equal doses of sucrose. Similar results were found when comparing a 40-gram bolus of isomalt and maltitol but were less severe than that of lactitol.

Stevia Leaf Extract. Stevia leaf extract contains various steviol glycosides such as stevioside, rebudioside A, rebudioside M and others with varying degrees of sweetness as well as organoleptic properties. Most varieties of steviol glycosides are approximately 250-350 times the sweetness of sucrose but possess a bitter aftertaste. Stevia leaf extract contains various polyphenols that possess anti-hypertensive and hyperglycemic effects as well as antioxidant properties.

Stevioside along with its metabolite, steviol inhibit oxidative phosphorylation in the liver of rodent mitochondria. Further investigation observed the inhibition of ATPase, NADH-oxidase, succinate-oxidase, succinate dehydrogenase, and glutamate dehydrogenase. The study suggested that stevioside and steviol acted as an uncoupler agent, therefore allowing it to disrupt oxidative phosphorylation.

Stevioside and steviol at a concentration of 1 mM has significantly suppressed endotoxin release of TNF-Alpha and Interleukin 1-Beta without exerting any major toxic effects. Closer observation reveals the suppression of IKK-beta, thereby preventing the release of NFkappa beta into the nucleus and allowing it to activate inflammatory pathways. Furthermore, stevioside was found to effectively increase phagocytic activity.

Stevioside has been shown to lower blood pressure in both healthy and hypertensive rodents. Stevioside can be effective in reducing blood pressure without attenuating serum catecholamines. The administration of stevioside on rodents for 20, 40, and 60-day durations on renal function revealed induced hypotension through the mechanism of natriuresis and diuresis. In contrast, results from a four-week human study focusing on the usage of crude stevia extract only showed neutral results. Another study was undertaken to investigate the effects of pure stevioside on mild hypertension patients. Based on two years of data collection it was found that 500 mg of stevioside significantly reduced diastolic and systolic blood pressure. Both of these studies also revealed that oral consumption of crude and pure stevioside can be safely tolerated for long-term consumption. Rebaudioside A stimulates insulin secretion in the presence of extracellular calcium in rodent studies. Stevioside and steviol enhanced insulin secretion in normal mice when they were incubated with the presence of glucose. In contrast a similar study experimented on mice with type-2 diabetes mellitus have validated similar results. Furthermore, oral administration of stevioside has helped delay the introduction of insulin resistance in rodents fed a high fructose diet. It was identified in the study that stevioside improves insulin sensitivity despite negative external factors. Other studies have revealed that stevioside significantly suppressed glucose response, therefore exerting hypoglycemic properties (Bertoni et al., 2010). It was later found that stevioside also attenuates levels of pyruvate carboxypeptidase (PEPCK) and PEPCK mRNA. Both proteins decreased after 15 days of treatment. The reduction of liver gene expression in rodents shows how stevioside can slow down gluconeogenesis. This mechanism may have a role in the reason how skeletal muscle studies have displayed modestly improved insulin action on both lean and obese mice (Bertoni et al., 2010).

The positive effects of stevioside have also been shown in human studies. In an acute double-blind study, patients with type-2 diabetes were supplemented with 1 gram of stevioside compared with 1 gram of maize starch by utilizing a blood draw. Blood samples were drawn at 30 and 240 minutes after ingestion of a meal. Both samples indicate reduced postprandial blood glucose levels, which indicates a positive effect on glucose metabolism. A clinical study involving sixty healthy volunteers has shown 200 mg of stevioside can effectively reduce blood glucose in an anabolic and catabolic state. The use range for stevioside is generally recognized as less than 1.0 percent of a formula for commercial applications. Therefore, a 16 ounce or 473 mL commercial drink would use

While in some ways satisfactory, the prior inventions or applications of nonnutritive sweeteners in commercial products fall short because sucrose is difficult to replace in standard recipes because of its functional properties and taste profile. By way of example, it is common to see recipes replace sucrose with sugar alcohols (polyols) or high intensity artificial and/or natural sweeteners. Although, other parts of the recipe often need to be changed to ensure the final product is similar to what it was originally intended to be. Common sugar alcohol replacements for sucrose include malitol, sorbitol, xylitol, and erythritol. Additionally, common artificial and natural sweetener replacements for sucrose include sucralose, saccharin, aspartame, Acesulfame. Although, sugar alcohols often are less sweet than sucrose and possess undesirable characteristics such as gastrointestinal distress. Conversely, artificial and natural sweeteners are well tolerated in the gut but are up to 600 times the intensity of sugar. With these traits, both cause difficulties in cooking and baking because they are not an even exchange for sucrose.

Soluble Corn Fiber. Fiber is proposed to be a crucial part of human health and metabolism. Current recommendations for fiber intake are 25 g per day for women and 38 g per day for men and the American diet lacks sufficient fiber intake. The lack of fiber in a diet may lead to a variety of metabolic health disorders including obesity, cardiovascular disease, gastrointestinal conditions, as well as metabolic syndrome. The increased risk of chronic diseases has been linked to the change in gut microflora which the flora been shown to offer health benefits. Therefore, a low fiber diet and the subsequent change in the gut microflora has seemed to shift the body into a state of metabolic dysfunction resulting in obesity.

Increased intake of dietary fiber has been shown to increase the concentration of beneficial microbes in the gut. Improved microbial colonization offers benefits to humans because it produces short chain fatty acids (SCFA) via the fermentation of fiber, which have a direct effect on metabolic function. Conversely, the complexity of microbial colonization has been shown to influence the occurrence of obesity due to the increased insulin resistance, elevated inflammation, and alterations in the secretion of gut hormones. Fiber is resistant to oral, stomach, and small intestine enzymatic hydrolysis.

Soluble corn fiber (SCF) is labeled as a functional fiber due to its impact on health which falls outside of a fiber's normal function. A functional property that is demonstrated by SCF is its ability to act as a prebiotic. A prebiotic is a food that will, “Selectively stimulate the growth and/or activity(ies) of one or a limited number of microbial genus(era)/species in the gut microbiota that confer(s) health benefits to the host,” Research on SCF has revealed it has unique fiber-like qualities through its ability to modulate breath hydrogen, increase stool weight, diversify the gut microbiome, and increase short chain fatty acid concentration.

A 25 g bolus dose of SCF has been shown to significantly increase breath hydrogen at 90, 120, 150, and 180 minutes compared to isomaltooligosaccharides and placebo control (p<0.0001). Similar effects were shown in 18 overweight men and women over a 24-hour period after consumption of 54.6±0.9 g/day of SCF. Results indicated those consuming SCF compared to a normal diet (p<0.05) containing no SCF. Although, when compared to inulin, varying doses (5, 10, and 15 g) and concentrations (70% and 85% bulk material) of SCF result in less breath hydrogen AUC than inulin (p<0.0001). These results indicate SCF is fermented in the gut but may not be as fermentable by gut microbiota as inulin. Although, SCF has been demonstrated to be more tolerable on GI symptoms than inulin.

Research demonstrates SCF has the potential to modulate gut microbiota and subsequentially short chain fatty acids (SCFA) improving obesity outcomes through the control of body weight. The SCFA resulting from microbial fermentation has demonstrated to have an indirect effect on intestinal barrier function, which when compromised, results in the release of endotoxins from the gastrointestinal tract into peripheral circulation promoting systemic inflammation in a condition known as Leaky Gut. More specifically, butyrate accounts for approximately 60-70% of intestinal fuel substrate and acetate, butyrate and propionate have demonstrated their ability to increase epithelial cell proliferation. This may be driven by glucagon-like peptide-2 (GLP-2). GLP-2 has been shown to increase gut barrier function, which has the potential to reduce oxidative stress. Furthermore, SCF have shown to regulate hunger via the gut-brain axis. Glucagon-like Peptide-1 (GLP-1) and peptide YY (PYY) are released by intestinal cells. Research has demonstrated SCFA stimulates the release of GLP-1 and PYY. GLP-1 is a regulator of glucose homeostasis and in conditions such as low fiber intake (low concentrations of SCFA) the suppressed secretion of GLP-1 has been linked to insulin resistance through the dysregulation of appetite. Furthermore, fiber intake has been linked to increases in the secretion of PYY through SCFA and the suppression of neuropeptide Y. This mechanism has been shown to decrease hunger, increase metabolic rate, and increase fat oxidation. GLP-1 in some cases may communicate with serotonin via the gut-brain axis resulting in decreased energy intake but this has not been demonstrated in humans. Another mechanism demonstrated in vitro is SCFA effect on leptin. Leptin is a satiety hormone released from the gut that communicates with the brain to reduce energy intake. Those who are insulin resistant, overweight or obese often suffer from leptin resistance where the action of leptin is suppressed leading to overeating.

A potential mechanism of SCFA, specifically butyrate, effects on a decrease in obesity is the AMPK->PCG-1α pathway. Adenosine monophosphate-activated protein (AMP) is present under low energy status of a cell; when the Adenosine monophosphate:Adenosine triphosphate (AMP: ATP) ratio is increased. This then stimulates adenosine monophosphate-activated protein kinase (AMPK) phosphorylation, which increases intracellular ATP production via fatty acid and glucose utilization. AMPK has twelve potential isoforms as α1, α2, β1 and β2 at the root. Although each isoform has a specific function, the AMPKα2 family is responsible for signaling the increase in ATP production. Furthermore, AMPKα2 stimulates Peroxisome proliferator-activated receptor-gamma coactivator (PCG-1α), which has been shown to increase mitochondrial biogenesis an anabolic process that may lead to increased cellular respiration and the ability to oxidize fatty acids for energy. Mitochondria are the powerhouse of the cell where the majority of ATP is produced to provide energy via the Krebs Cycle and Electron Transport Chain. An increase in mitochondrial biogenesis may lead to an increase in fatty acid oxidation due to the increase in mitochondria. An increase in fat oxidation may lead to a reduction in body weight, increase insulin sensitivity, and decreased mitochondrial dysfunction. It has been shown that the SCFA butyrate stimulates PCG-1α, which as demonstrated may be a potential mechanism to a decrease in obesity.

Although the effects of fiber on the gut microbiome have been extensively researched, there has been less research specific to soluble corn fiber. To better understand soluble corn fiber's effect on specific gut microbes and short chain fatty acids, more clinical trials need to be conducted to understand optimal dosing, tolerable dosing and consumption across the lifespan. There has been a push for the use of functional fibers and their use in common packaged foods and sugar sweetened beverages because of the positive health effects that fiber provides and to improve weight status by decreasing obesity. Soluble corn fiber is a likely candidate as this fiber because it is tasteless, provides no energy, and is fully soluble in water. Although, we do not completely understand how this will affect health. Current literature demonstrates soluble corn fiber may improve the balance of microbes in the gut that have positive health effects while reducing those that may have deleterious health effects. Furthermore, more research needs to be conducted on the effects of soluble corn fiber and its effects on short chain fatty acids.

Salt (Sodium Chloride). Salt, or sodium chloride, is a common taste and flavor enhancer. Salt excites receptors on the tongue that produce a chemical response traveling to the brain to sense its presence. This effect will concurrently make other tastes more or less intense. There are five generally recognized taste experiences including salt, sour, sweet, bitter, and umami. However, salt enhances the flavors of other food and is often added to foods to enhance the sensory and organoleptic profile by making foods more desirable. Furthermore, salt is used as a natural preservative because it reduces water activity by associating with water's polarity and lowering free water in a mixture (need citation). One of the more important attributes of salt is its ability to improve palatability. Salt's ability to improves palatability has yet to be elucidated. However, possible theories include evolutionary necessity and/or salts ability to modify flavors such as reducing bitter or increasing sweet (Boon et al., 2010)

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

### BRIEF SUMMARY OF THE INVENTION

Disclosed is a nonnutritive food sweetener technology designed to provide an alternative to other traditionally used sweeteners in consumer-packaged goods (CPG) such as beverages, baked goods, confections, and candies. The purpose of the Nonnutritive Food Sweetener is to address the growing trends in obesity across all populations (Moss, 2013). Therefore, to address this concern, the discussed technology utilizes three commercially available sweeteners in a unique ratio that have no effect on blood sugar and minimal effect on insulin. The nonnutritive food sweetener utilizes allulose, commonly known as D-Psicose or D-allulose; erythritol, and stevia leaf extract in the form of diterpene glycosides; specifically stevioside, rebaudioside A and/or M.

The present invention provides a nonnutritive sweetener which includes Erythritol, Allulose, Soluble Corn and/or Tapioca Fiber, Stevia Extract, Salt (Sodium Chloride) and a Natural Masking Flavor at a ratio of approximately 37.58-56.37% Erythritol, 37.54-56.31% Allulose, 4.734-7.10% Soluble Corn and/or Tapioca Fiber, 0.121%-0.182% Stevia Extract, 0.015-0.023% Salt (Sodium Chloride), and 0.009%-0.013% Natural Masking Flavor. The allulose may be either one of d-psicose and d-allulose. The soluble fiber may be either soluble corn fiber and/or soluble tapioca fiber. The stevia extract is preferably a steviol glycoside including at least one of rebaudioside A, rebaudioside B, rebaudioside M, and steviosides.

The sweetener according to the present invention overcomes the drawbacks of known nutritive and nonnutritive sweeteners by providing a low-calorie, non-insulinogenic alternative which has substantially identical functionality and behavior to sugar when used in food products. The sweetener can be used as a nonnutritive ingredient in food and beverage applications that use high fructose corn syrup or fructose, sucrose or cane sugar, agave nectar, honey, rice syrup and concentrated fruit sources such as fruit pastes or dried/dehydrated fruit as nutritive sweeteners, bulking agents, preservatives, flavor enhancers, colorings, thickeners, anticoagulants, and to reduce water activity. The non-caloric, nonnutritive invention replaces caloric nutritive ingredients in food and beverage application.

The invention may be used as a single ingredient for a complete or partial replacement of nutritive sweeteners including high fructose corn syrup or fructose, sucrose or cane sugar, agave nectar, honey, rice syrup and concentrated fruit sources such as fruit pastes or dried/dehydrated fruit in food or beverage products.

In one embodiment, a nonnutritive sweetener composition comprises 37.58-56.37% erythritol, 37.54-56.31% allulose, 4.734-7.10% soluble fiber, 0.121%-0.182% stevia extract comprising diterpene glycosides, 0.015-0.023% sodium chloride, and 0.009%-0.013% natural masking flavor. The soluble fiber is selected from the group consisting of inulin, fructo-oligosaccharides, soluble tapioca fiber, polydextrose, isomalto-oligosaccharides, maltodextrin, and combinations thereof. Optionally, the stevia extract is selected from the group consisting of rebaudioside A, rebaudioside B, rebaudioside M, other steviosides and combinations thereof.

In another embodiment, the nonnutritive sweetener composition comprises 42.278-51.673% erythritol, 42.233%-51.618% allulose, 5.325%-6.509% soluble fiber, 0.137%-0.167% stevia leaf extract, 0.017%-0.021% sodium chloride, and 0.01%-0.012% natural masking flavor of the nonnutritive sweetener.

In another embodiment, the nonnutritive sweetener composition comprises 46.976% erythritol, 46.926% allulose, 5.917% soluble fiber, 0.152% stevia leaf extract, 0.019% sodium chloride, and 0.011% natural masking flavor by weight of the nonnutritive sweetener. Optionally, the composition further comprises at least one food product selected from the group consisting of dairy products, cheese products, frozen desserts, bakery products, fruit and vegetable products, beverages, and cacao based products.

In one embodiment, the nonnutritive sweetener composition is manufactured using a method comprising adding erythritol and a fiber, preferably soluble corn fiber and/or tapioca fiber to a mixing vessel. The amounts of the ingredients used are according to the formulation being used. Several exemplary formulations have been provided below. The mixing vessel may be a stainless-steel mixing tank, a jacketed or non-jacketed kettle, or crystallization tank with a paddle type mixing attachment. The mixing vessel includes a heating element such as gas, water, electric or direct induction capable of achieving temperature of 20-260° C., preferably 50-100° C. and more precisely 85-98.9° C.

Next, cold water, preferably reverse-osmosis or deionized water, equal to the total weight of the dry goods, i.e. the erythritol/fiber composition is added to the aforementioned mixing vessel. The cold water used dissolve the erythritol and fiber before adding heat to prevent clumping/gelatinization of the fiber. The tank/kettle's mixing attachment is then turned on to 45-60 rotations per minute (RPM) to form a semiliquid slurry mixture of particles weakly suspended in the water. The temperature on the mixing vessel is then increased to 85-98.9° C. to cause water evaporation and increase the Brix (° Bx) to 85-98.5° Bx, preferably 90-96° Bx and more preferably 94-95° Bx, which may be measured by refractometry via Brix Refractometer while mixing. Once the mixture has reached the adequate Brix (° Bx) of 85-98.5° Bx, preferably 90-96° Bx and more preferably 94-95° Bx, dry allulose is added to the mixture and the heat is removed.

The mixer on the mixing vessel continues to mix at 45-60 rotations per minute to at least partially dissolve the added allulose, allowing it to coat, or complex with, the erythritol and soluble corn and/or tapioca fiber. Removing the mixture from heat prevents Maillard browning of the allulose, while the heat of the mixture causes water to evaporate. Without being bound by theory, the inventors believe that the relatively low temperature and gradual cooling facilitate the formation of erythritol-allulose complexes, and their crystallization of the complex rather than the individual constituents. The mixture is mixed until desired water content of the mixture is ≤5%, thus forming a moist erythritol-allulose crystalline mixture.

The moist erythritol-allulose crystalline mixture is then removed from the mixing vessel and transferred to the hopper of a dry powder roller compactor with a granulating oscillator. The feed screw is be set to 20-65 rotations per minute, roller speed is to be set to 10-20 rotations per minute, and the roller pressure is to be set to 100-150 Kilonewtons (kN). The granulating oscillator is to be equipped with rollers rotating at 40-50 rotations per minute and a 18-35 US mesh screen (0.5-1.0 mm; 500-1000 microns). This forms a granular erythritol-allulose crystalline mixture.

Stevia leaf extract, salt (sodium chloride), and a masking flavor are mixed independently in an appropriately size powder mixing vessel such as a rotary mixer, V-style or Cone-style mixer equipped with a reverse rotary agitator for 10-25 minutes, preferably 12-18 minutes and more precisely 14-16 minutes at a speed of 15 rotations per minute with the reverse rotary agitator rotating at a speed of 10 rotations per minute.

The granular erythritol-allulose crystalline mixture is added to the stevia leaf extract, salt (sodium chloride), and masking flavor mixture in 20% increments. Upon each 20% addition, the granules are remixed for the following intervals—
20% of erythritol-allulose crystalline mixture with stevia leaf extract, salt (sodium chloride), and the natural masking flavor mixture for 5-10 minutes, preferably 6-9 minutes and more precisely 7-8 minutes at a speed of 15 rotations per minute with the reverse rotary agitator rotating at a speed of 10 rotations per minute.
40% of erythritol-allulose crystalline mixture with stevia leaf extract, salt (sodium chloride), and the natural masking flavor mixture for 5-10 minutes, preferably 6-9 minutes and more precisely 7-8 minutes at a speed of 15 rotations per minute with the reverse rotary agitator rotating at a speed of 10 rotations per minute.
60% of erythritol-allulose crystalline mixture with stevia leaf extract, salt (sodium chloride), and the natural masking flavor mixture for 2-6 minutes, preferably 3-5 minutes and more precisely 4 minutes at a speed of 15 rotations per minute with the reverse rotary agitator rotating at a speed of 10 rotations per minute.
80% of erythritol-allulose crystalline mixture with stevia leaf extract, salt (sodium chloride), and the natural masking flavor mixture for 2-6 minutes, preferably 3-5 minutes and more precisely 4 minutes at a speed of 15 rotations per minute with the reverse rotary agitator rotating at a speed of 10 rotations per minute.
100% of erythritol-allulose crystalline mixture with stevia leaf extract, salt (sodium chloride), and the natural masking flavor mixture for 2-6 minutes, preferably 3-5 minutes and more precisely 4 minutes at a speed of 15 rotations per minute with the reverse rotary agitator rotating at a speed of 10 rotations per minute.

It is therefore an object of the present invention to provide a nonnutritive sweetener composition that has texture and physical properties similar to sucrose and which is suitable for use in cooking.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of chocolate chip cookies made using sucrose of the prior art;

FIG. 2 is a perspective view chocolate chip cookies made using a nonnutritive sweetener in accordance with the principles of the invention;

FIG. 3 is a perspective view of a commercially available low calorie chocolate chip cookie mix of the prior art.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices may be shown in block diagram form in order to facilitate describing the various embodiments herein.

Various embodiments of the disclosure could also include permutations of the various elements as if each dependent claim was a multiple dependent claim incorporating the limitations of each of the preceding dependent claims as well as the independent claims. Unless explicitly stated otherwise, such permutations are expressly within the scope of this disclosure. Similarly, the disclosure should be interpreted as including permutations of the various elements disclosed in the Figures, unless the various elements are clearly mutually exclusive.

Unless otherwise indicated, all numbers expressing quantities of ingredients, dimensions reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

To address the concern with nutritive and prior art nonnutritive sweeteners, the inventive nonnutritive sweetener composition utilizes six commercially available substrates in an inventive ratio and an inventive method of manufacturing the composition. The sweetener has no material effect on blood sugar and a minimal effect on serum insulin. The non-nutritive food sweetener utilizes erythritol, allulose, commonly known as D-Psicose or D-allulose; soluble corn and/or tapioca fiber; stevia leaf extract (in the form of isolated steviol glycosides from diterpene glycosides; specifically, stevioside, rebaudioside A and/or rebaudioside M in a concentration of greater-than or equal to 97% and 95%, respectively; salt (sodium chloride); and a natural masking agent.

Below is the Fischer Model illustrating the similarities between caloric fructose (D-Fructose) and low-caloric allulose (D-Psicose); one of the sweeteners found in the invention.

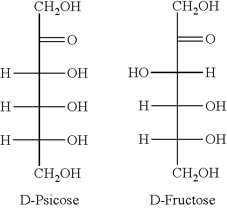 [SMILES: O=C(CO)C(O)C(O)C(O)CO ; O=C(CO)C(O)C(O)C(O)CO]

Below is the Bond-line Model of fructose (D-Fructose) and allulose (D-Psicose).

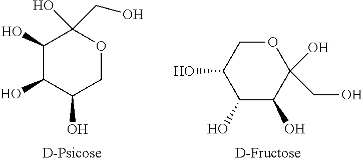 [SMILES: OCC1(O)OC[C@@H](O)[C@@H](O)[C@H]1O ; OCC1(O)OC[C@@H](O)[C@@H](O)[C@@H]1O]

The similarities between fructose and glucose (the two monosaccharides found in common table/baking sugar or sucrose) and erythritol, which is a known acceptable low-caloric substitution for sucrose are shown below.

In the present invention, the ingredient allulose is used because it does not possess the negative characteristics of sugar alcohols and artificial or natural sweeteners. Allulose is a commonly less used sugar and is an epimer of fructose with the reversal of the —H and OH group on carbon-three. Allulose is approximately 0.7 times the sweetness intensity of sucrose but functions similarly in baking because it has the capacity to add texture, sweetness, retain water (tenderness), suspend other constituents in solution, impact the browning of food through the maillard reaction, act as a preservative and contribute flavor & color.

The second sweetener present in the formulation is erythritol, a sugar alcohol or polyol, which is produced via fermentation of starch or sucrose. Erythritol does not have the same functionality as sucrose in cooking and baking because it does not contribute to the maillard reaction nor does it contribute to color or flavor. Additionally, erythritol is approximately 0.6-0.7 times the sweetness intensity of sucrose and possesses a cooling effect on the tongue. However, erythritol does provide bulk, similar to sucrose, and does not have undesirable characteristics because it is non-glycemic and does not negatively affect the gastrointestinal tract.

The final ingredient in the formulation is stevia leaf extract in the form of the steviol glycosides, rebudioside A and/or rebudioside M. Stevia is about 250-350 times the sweetness intensity of sucrose but possesses none of the beneficial qualities of sucrose incooking or baking.

The unique combination of sweeteners within the formulation and manufacturing methods of the invention, based on their percentages and quality, have the functional and organoleptic characteristics more similar to sucrose than other nonnutritive sweeteners, such that the are well suited for cooking. Furthermore, the combination of erythritol, allulose, soluble corn and/or tapioca fiber, stevia leaf extract, salt (sodium chloride) and a natural masking flavor does not materially affect blood glucose or insulin; whereas sucrose possesses glucogenic and insulinogenic properties. This is evidenced by the peer-reviewed trials conducted on allulose, erythritol, and stevia leaf extract showing a calorie content of 0.1 kcal/g, 0.2 kcal/gram, and 0 kcal/g, respectively.

Furthermore, the glycemic index of erythritol, allulose, soluble corn and/or tapioca fiber, stevia leaf extract, salt (sodium chloride) and a natural masking flavor is one (1), one (1), twenty-five (25), zero (0), zero (zero), and zero (0), respectively. The most notable quality of the combination of erythritol, allulose, soluble corn and/or tapioca fiber, stevia leaf extract, salt (sodium chloride) and a natural masking flavor is its one-to-one replacement by weight in cooking and baking recipes for sucrose. This characteristic makes the proposed sweetening blend unique. Due to the properties of the inventive sweetener, it can be used across various food products including dairy, cheese and related cheese products, frozen desserts, bakery products (including mixes), canned fruit, fruit butters, jellies, preserves, and related products, fruit pies, vegetable juices, egg products, cacao products, beverages product, sweeteners and tables syrups, food dressings, flavorings. Formulas for the various food products are provided below as different embodiments of the invention.

Sucrose is generally preferred in most baking because of its physical properties. Baked goods using sucrose are generally considered to have a superior texture, flavor and consistency. Many nonnutritive sweeteners have an open chain structure, similar to dissolved glucose. In addition, different forms of sucrose, e.g. powdered sugar and granulated sugar, are used for different baked goods due to the properties they impart to foods prepared with them. Sucrose is generally preferred over fructose and glucose because of these properties. However, many nonnutritive sweeteners, and many natural sugars such as glucose, have inferior physical properties so that they are not well suited for cooking. Without being bound by theory, the inventors believe that the superior physical properties of the present invention are due to the complexing of erythritol and allulose, which form a complex which forms small, heterogeneous crystals of the complex, rather than a mixture of erythritol crystals and allulose crystals. This heterogenous crystal structure causes the present invention to exhibit properties similar to that of sucrose. In addition, the manufacturing process creates a uniform particulate size which also imparts superior properties to the composition.

To ensure uniformity of the particulate size of the unique combination of sweeteners, flavoring aids and flavor enhancers, we employed multiple techniques to achieve the desired outcome and functionality of the nonnutritive sweetener mixture. Sucrose is comprised of the monosaccharides glucose and fructose forming a disaccharide via a glycosidic bond. The bond between glucose and fructose indicates the molecule is a non-reducing sugar or sugar that is not freely oxidized by a weak reagent. Conversely, glucose and fructose are freely oxidized by a weak reagent. The glycosidic bond between glucose and fructose in sucrose occurs at the anomeric carbons of each molecule, which, when oxidized, prevents the molecules from dissociating and changing from a hexose and pentose ring structure to an open-chain structure. The conformational change from a ring structure to a chain structure is a phenomenon that occurs in reducing sugars because of the free aldehyde or ketone group and loss of an electron. The ability of sucrose to retain its paired ring structure during oxidation or processing is what provides the functional characteristics as a food ingredient.

As the present invention combines erythritol, allulose, soluble corn and/or tapioca fiber, stevia leaf extract, salt (sodium chloride) and a natural masking flavor, it is important to achieve a consistent moisture content and particulate size to mirror the functional characteristics of sucrose. Therefore, we have developed a process allowing us to achieve uniformity and maintain functionality. The following procedure may be used to manufacture the composition of the present invention. The amounts of the various constituents will vary according to the formulas of the various embodiments, but the process is the same.

Erythritol and a fiber, preferably soluble corn fiber and/or tapioca fiber, is added to a mixing vessel. The amounts of the ingredients used are according to the formulation being used. Several exemplary formulations have been provided below. The mixing vessel may be a stainless-steel mixing tank, a jacketed or non-jacketed kettle, or crystallization tank with a paddle type mixing attachment. The mixing vessel includes a heating element such as gas, water, electric or direct induction capable of achieving temperature of 20-260° C., preferably 50-100° C. and more precisely 85-98.9° C.

Cold water, preferably reverse-osmosis or deionized water, equal to the total weight of the dry goods, i.e. the erythritol/fiber composition is added to the aforementioned mixing vessel. The cold water used dissolve the erythritol and fiber before adding heat to prevent clumping/gelatinization of the fiber.

The tank/kettle's mixing attachment is then turned on to 45-60 rotations per minute (RPM) to form a semiliquid slurry mixture of particles weakly suspended in the water.

The temperature on the mixing vessel is then increased to 85-98.9° C. to cause water evaporation and increase the Brix (° Bx) to 85-98.5° Bx, preferably 90-96° Bx and more preferably 94-95° Bx, which may be measured by refractometry via Brix Refractometer while mixing.

Once the mixture has reached the adequate Brix (° Bx) of 85-98.5° Bx, preferably 90-96° Bx and more preferably 94-95° Bx, dry allulose is added to the mixture and the heat is removed.

The mixer on the mixing vessel continues to mix at 45-60 rotations per minute to at least partially dissolve the added allulose, allowing it to coat, or complex with, the erythritol and soluble corn and/or tapioca fiber. Removing the mixture from heat prevents Maillard browning of the allulose, while the heat of the mixture causes water to evaporate. Without being bound by theory, the inventors believe that the relatively low temperature and gradual cooling facilitate the formation of erythritol-allulose complexes, and their crystallization of the complex rather than the individual constituents. The mixture is mixed until desired water content of the mixture is <5%, thus forming a moist erythritol-allulose crystalline mixture.

The moist erythritol-allulose crystalline mixture is then removed from the mixing vessel and transferred to the hopper of a dry powder roller compactor with a granulating oscillator. The feed screw is be set to 20-65 rotations per minute, roller speed is to be set to 10-20 rotations per minute, and the roller pressure is to be set to 100-150 Kilonewtons (kN). The granulating oscillator is to be equipped with rollers rotating at 40-50 rotations per minute and a 18-35 US mesh screen (0.5-1.0 mm; 500-1000 microns). This forms a granular erythritol-allulose crystalline mixture.

Stevia leaf extract, salt (sodium chloride), and a masking flavor are mixed independently in an appropriately size powder mixing vessel such as a rotary mixer, V-style or Cone-style mixer equipped with a reverse rotary agitator for 10-25 minutes, preferably 12-18 minutes and more precisely 14-16 minutes at a speed of 15 rotations per minute with the reverse rotary agitator rotating at a speed of 10 rotations per minute.

The granular erythritol-allulose crystalline mixture is added to the stevia leaf extract, salt (sodium chloride), and masking flavor mixture in 20% increments. Upon each 20% addition, the granules are remixed for the following intervals—
20% of erythritol-allulose crystalline mixture with stevia leaf extract, salt (sodium chloride), and the natural masking flavor mixture for 5-10 minutes, preferably 6-9 minutes and more precisely 7-8 minutes at a speed of 15 rotations per minute with the reverse rotary agitator rotating at a speed of 10 rotations per minute.
40% of erythritol-allulose crystalline mixture with stevia leaf extract, salt (sodium chloride), and the natural masking flavor mixture for 5-10 minutes, preferably 6-9 minutes and more precisely 7-8 minutes at a speed of 15 rotations per minute with the reverse rotary agitator rotating at a speed of 10 rotations per minute.
60% of erythritol-allulose crystalline mixture with stevia leaf extract, salt (sodium chloride), and the natural masking flavor mixture for 2-6 minutes, preferably 3-5 minutes and more precisely 4 minutes at a speed of 15 rotations per minute with the reverse rotary agitator rotating at a speed of 10 rotations per minute.
80% of erythritol-allulose crystalline mixture with stevia leaf extract, salt (sodium chloride), and the natural masking flavor mixture for 2-6 minutes, preferably 3-5 minutes and more precisely 4 minutes at a speed of 15 rotations per minute with the reverse rotary agitator rotating at a speed of 10 rotations per minute.
100% of erythritol-allulose crystalline mixture with stevia leaf extract, salt (sodium chloride), and the natural masking flavor mixture for 2-6 minutes, preferably 3-5 minutes and more precisely 4 minutes at a speed of 15 rotations per minute with the reverse rotary agitator rotating at a speed of 10 rotations per minute.

The gradual blending of the two mixtures ensures a uniform mixture. The uniform mixture is then processed through a dry powder roller compactor with granulating oscillator again. The feed screw is set to 20-65 rotations per minute, roller speed is to be set to 10-20 rotations per minute, and the roller pressure is to be set to 100-150 Kilonewtons (kN). The granulating oscillator is to be equipped with rollers rotating at 40-50 rotations per minute and a 18-35 US mesh screen (0.5-1.0 mm; 500-1000 microns).

The resulting granular nonnutritive sweetener composition is then added to a rotary drum dryer and dried for 5-20 minutes, preferably 7-17 minutes and more preferably 10-14 minutes at a speed of 4-8 rotations per minute and input temperature of air of 65-93° C. The sugar then leaves the dryer at a temperature of 41-51° C. and is transferred to a rotary drum cooler with no heat input. The mixture leaves the cooler at 35-44° C. with a moisture content of <1%, preferably <0.5%.

A variety of flavor masking agents may be used, including aromatic amines, essential oils, extracts, e.g. vanilla and almond extracts, and oleoresins. The invention is suitable with any commonly used flavoring agents.

The nonnutritive sweetener composition is a suitable substitute for sucrose for a variety of cooking methods. Provided below is a non-exhaustive list of uses for the nonnutritive sweetener compositions, including exemplary formulations to be used when performing the above described method of manufacture.

Dairy Products. According to one embodiment, the present invention is incorporated into a dairy product such as a flavored dairy yogurt product comprising a nonnutritive sweetener having a useful range combination (same functional and organoleptic characteristics as sucrose) of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a dairy product such as mousse comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention, a dairy product such as whipped cream/creme comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a dairy product such as whipped topping comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a dairy product such as Chantilly cream/creme having a nonnutritive sweetener comprising a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a dairy product such as sweetened or non-sweetened flavored milk comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a still further embodiment of the present invention a dairy product such as flavored or non-flavored powdered creamers comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, salt (sodium chloride), and 0.011% natural masking flavor by weight of the nonnutritive sweetener.

According to still another embodiment of the present invention a dairy product such as flavored or non-flavored liquid creamers comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a dairy product such as flavored or non-flavored liquid creamers comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.235%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Cheese and Related Cheese Products. According to yet another embodiment of the present invention a cheese and related cheese product such as flavored or non-flavored cream cheese spread comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Frozen Desserts. According to another embodiment of the present invention a frozen dessert such as ice cream comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a frozen dessert such as frozen yogurt comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment of the present invention a frozen dessert such as gelato comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a frozen dessert such as sorbet comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Bakery Products. According to one embodiment of the present invention a bakery product such as rolls comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a bakery product such as sweet rolls comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment, the present invention provides a bakery product such as non-fermented bread dough comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a bakery product such as short dough comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener

According to yet another embodiment of the present invention a bakery product such as fermented dough comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a bakery product such as cakes, cupcakes, and petite fours comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, salt (sodium chloride), and 0.011% natural masking flavor by weight of the nonnutritive sweetener

According to still another embodiment of the present invention a bakery product such as non-yeast doughnuts or cake doughnuts comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment, the present invention a bakery product such as pastry dough comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.235%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a bakery product such as laminated dough comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment of the present invention a bakery product such as a muffin comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.235%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a bakery product such as a muffin or scone comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment, the present invention a bakery product such as pie dough and/or tart dough comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment, the present invention a bakery product such as streusel comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet a further embodiment, the present invention a bakery product such as a pie comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment, the present invention a bakery product such as a cobbler comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment, the present invention a bakery product such as a galette comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a still further embodiment of the present invention a bakery product such as cookies with chocolate including chocolate chip cookies, double chocolate chip cookies, and oatmeal chocolate chip cookies comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, salt (sodium chloride), and 0.011% natural masking flavor by weight of the nonnutritive sweetener.

According to still another embodiment of the present invention a bakery product such as sugar cookie variations including snickerdoodle cookies, sugar cookies, butter cookies, and Christmas cookies comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a yet further embodiment of the present invention a bakery product such as oatmeal cookie variations including oatmeal cookies and oatmeal raisin cookies comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a bakery product such as bar cookie variations including puffed rice cereal cookie bars, cheesecake bars, lemon bars, and turtle bars comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment, the present invention a bakery product such as peanut butter cookie variations including peanut butter cookies and peanut butter chocolate chip cookies comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.235%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment of the present invention a bakery product such as waffle cookies, biscotti's, gingersnaps, and shortbread cookies comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a yet further embodiment of the present invention a bakery product such as brownies or blondies comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a bakery product such as macaroons comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment, the present invention a bakery product such as pancakes and pre-packaged pancake mix comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a bakery product such as waffles and pre-packaged waffle mix comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment, the present invention a bakery product such as crackers comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a still further embodiment of the present invention a bakery product such as chiffon or chiffon cake comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a bakery product such as sponge or sponge cake comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a bakery product such as torte comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a bakery product such as cheesecake comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a still further embodiment of the present invention a bakery product such as pre-packaged baking mix used to make any of the aforementioned products discussed in the bakery products section comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Canned Fruit. According to one embodiment, the present invention a canned fruit such as fruit cups comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Fruit Butters, Jellies, Preserves, and Related Products. According to one embodiment of the present invention fruit butters, jellies, preserves, and related products such as sweet fillings comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.235%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention fruit butters, jellies, preserves, and related products such as sweet glazes comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention fruit butters, jellies, preserves, and related products such as applesauce comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment of the present invention fruit butters, jellies, preserves, and related products such as fruit gummies comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention fruit butters, jellies, preserves, and related products such as fruit gummies comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention fruit butters, jellies, preserves, and related products such as gummy candies comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention fruit butters, jellies, preserves, and related products such as gummy vitamins or multiple vitamins (multivitamins) comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention fruit butters, jellies, preserves, and related products such as fruit butters comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, salt (sodium chloride), and 0.011% natural masking flavor by weight of the nonnutritive sweetener.

According to still another embodiment of the present invention fruit butters, jellies, preserves, and related products such as fruit jelly comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention fruit butters, jellies, preserves, and related products such as fruit preserves and jams comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, salt (sodium chloride), and 0.011% natural masking flavor by weight of the nonnutritive sweetener.

Fruit Pies. According to one embodiment of the present invention a fruit pie comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Vegetable Juices. According to one embodiment of the present invention a vegetable juice comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.235%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Egg and Egg Products. According to one embodiment, the present invention an egg and egg product such as custard comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention an egg and egg product such as curd comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.235%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Cacao Products. According to one embodiment of the present invention a cacao product such as chocolate couverture comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a cacao product such as chocolate ganache comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a cacao product such as white chocolate comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Beverage Products. According to a further embodiment of the present invention a beverage product such as alcoholic and non-alcoholic carbonated beverages comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a beverage product such as alcoholic non-alcoholic non-carbonated beverages comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a beverage product such as carbonated coffee and tea beverages comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a beverage product such as non-carbonated coffee and/or tea beverages comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, salt (sodium chloride), and 0.011% natural masking flavor by weight of the nonnutritive sweetener.

According to a further embodiment of the present invention a beverage product such as cocktail and/or alcoholic and/or non-alcoholic drink mixers comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a beverage product such as carbonated or non-carbonated fermented beverages comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, salt (sodium chloride), and 0.011% natural masking flavor by weight of the nonnutritive sweetener.

According to another embodiment of the present invention a beverage product such as non-dairy milk beverages comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Sweeteners and Table Syrups/Sirups. According to one embodiment of the present invention a sweetener and table syrup/sirup such as flavored syrup comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Food Dressings and Flavorings. According to one embodiment of the present invention a food dressing and flavoring such as ketchup comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a food dressing and flavoring such as barbecue and/or barbecue sauce comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618%, allulose, 5.235%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a food dressing and flavoring such as mustard comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a food dressing and flavoring such as relish comprise a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment of the present invention a food dressing and flavoring such as steak sauce comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a food dressing and flavoring such as red, tomato based spaghetti and/or pasta sauce comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a food dressing and flavoring such as white spaghetti and/or pasta sauce comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a food dressing and flavoring such as pizza sauce comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment of the present invention a food dressing and flavoring such as teriyaki and/or teriyaki sauce comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, salt (sodium chloride), and 0.011% natural masking flavor by weight of the nonnutritive sweetener.

According to still another embodiment of the present invention a food dressing and flavoring such as food marinades and/or marinades comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment of the present invention a food dressing and flavoring such as oyster sauce comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a food dressing and flavoring such as soy sauce or tamari and soy-based glaze and tamari based glaze comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a food dressing and flavoring such as eel sauce comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment, the present invention a food dressing and flavoring such as orange sauce comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

Undefined Food Products or Consumer Packaged Goods. According to one embodiment of the present invention a chibout cream/crème comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a frosting comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention provides a snack bar comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a plant-based snack bar comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention an energy bar comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a plant based energy bar comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a protein bar comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment, the present invention a plant-based protein bar comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment of the present invention a meal replacement bar comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a plant based meal replacement bar comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention provides a fondant comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a caramel sauce and/or caramel candy comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a pickled fruit and/or vegetable comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment of the present invention a granola comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a granola bar comprises a nonnutritive sweetener having a useful range of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a cereal bar comprises a nonnutritive sweetener having a useful range of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a fiber bar comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a candied nut and/or legume comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a whey protein such as hydrolyzed whey protein, whey protein isolate and whey protein concentrate comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a milk protein such as milk protein isolate and/or milk protein concentrate comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a casein protein comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a plant based protein powder such as soy protein, wheat protein, pea protein, hemp protein, brown rice protein, pumpkin protein, sunflower protein, chia seed protein, peanut protein, almond protein, quinoa protein, lentil protein, flaxseed protein and sacha inchi protein comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention an instant oatmeal and/or hot breakfast cereal comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention a breakfast cereal comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to a further embodiment of the present invention a bottled protein supplement comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to another embodiment of the present invention a sweetener packet comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a flavored or non-flavored non-dairy powdered creamer comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to one embodiment of the present invention provides a flavored or non-flavored non-dairy liquid creamer comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a flavored or non-flavored non-dairy yogurt comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a flavored or non-flavored non-dairy milk comprises a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to yet another embodiment of the present invention an artificially and/or naturally flavored, sweetened gelatin dessert comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention an artificially and/or naturally flavored, sweetened pudding and/or pie filling comprising a nonnutritive sweetener having a useful range combination of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

According to still another embodiment of the present invention a nut butter and/or spread comprises a nonnutritive sweetener having a useful range of erythritol, allulose, soluble corn and/or tapioca fiber, stevia leaf extract, salt (sodium chloride) and a natural masking flavor at a ratio of approximately 37.58-56.37% erythritol, 37.54-56.31% allulose, 4.734-7.10% soluble corn and/or tapioca Fiber, 0.121%-0.182% stevia leaf extract, 0.015-0.023%, salt (sodium chloride), and 0.009%-0.013% natural masking flavor of the nonnutritive sweetener. In a preferred non-limiting embodiment, the respective ranges of erythritol, allulose, soluble corn and/or tapioca fiber, stevia leaf extract, salt (sodium chloride) and a natural masking flavor at a ratio of approximately 42.278-51.673% erythritol, 42.233%-51.618% allulose, 5.325%-6.509% soluble corn and/or tapioca Fiber, 0.137%-0.167% stevia leaf extract, 0.017%-0.021% salt (sodium chloride), and 0.01%-0.012% natural masking flavor of the nonnutritive sweetener. In a preferred non-limiting embodiment, the exact amount of erythritol, allulose, soluble corn and/or tapioca fiber, stevia leaf extract, salt (sodium chloride) and a natural masking flavor at the precise amounts of 46.976% erythritol, 46.926% allulose, 5.917% soluble corn and/or tapioca Fiber, 0.152% stevia leaf extract, 0.019% salt (sodium chloride), and 0.011% natural masking flavor by weight of the nonnutritive sweetener.

To test the invention, the nonnutritive sweetener composition was in a chocolate chip cookie formulation and compared to standard sucrose table sugar and a commercially available low-calorie baking blend replacement comprising maltodextrin and sucralose. The results were analyzed using a visible comparison of particle size, a visible comparison of flowability, and measurements of blood glucose over 120 minutes comparing a 5 gram, 10 gram, and 15 gram dose.

Standard Chocolate Cookie Recipe

| Ingredients | Weight/measure | |
|---|---|---|
| Unsalted butter | 75 | grams |
| Granulated sugar | 90 | grams |
| Brown sugar | 30 | grams |
| Salt | 2 | grams |
| Eggs | 45 | grams |
| Vanilla extract | 2.5 | grams |
| All-purpose flour | 150 | grams |
| Baking soda | 2 | grams |
| Chocolate chips | 150 | grams |

Standard Chocolate Chip Cookie Recipe Method of Production

Method

1. Scale ingredients, bring butter & eggs to room temperature, line a sheet
pan with parchment paper, and preheat oven to 375° F. (190.6° C.).
2. Cream together butter, sugar(s), and salt in a tabletop mixer using a
paddle attachment for 60-90 seconds.
3. Add eggs and vanilla, then mix for 30-45 seconds.
4. Add flour and baking soda, then mix for 30-45 seconds.
5. Using the drop method, drop batter onto sheet pan in 30-gram
increments.
6. Place sheet pan in the oven and bake for 7-9 minutes.
7. Remove sheet pan from oven, then transfer cookies to cooling rack and
cool for 2-3 minutes.

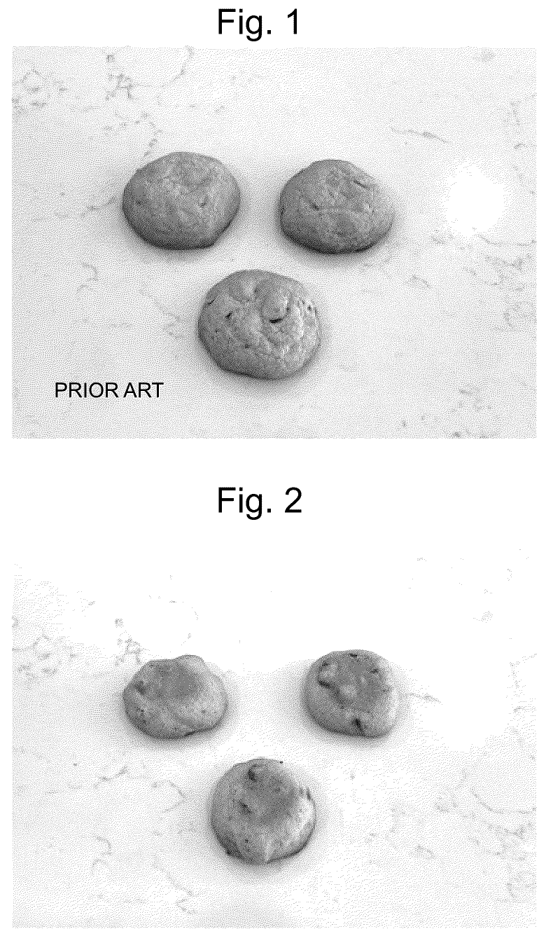

Cookies made using this recipe are shown in FIG. 1.

Nonnutritive Sweetener Composition Chocolate Chip Cookie Recipe

| Ingredients | Weight/measure | |
|---|---|---|
| Unsalted butter | 75 | grams |
| Nonnutritive Sweetener Composition | 90 | grams |
| Brown sugar | 30 | grams |
| Salt | 2 | grams |
| Eggs | 45 | grams |
| Vanilla extract | 2.5 | grams |
| All-purpose flour | 150 | grams |
| Baking soda | 2 | grams |
| Chocolate chips | 150 | grams |

Nonnutritive Sweetener Composition Method of Production

Method

1. Scale ingredients, bring butter & eggs to room temperature, line a sheet
pan with parchment paper, and preheat oven to 375° F. (190.6° C.).
2. Cream together butter, sweetener(s), and salt in a tabletop mixer using a
paddle attachment for 60-90 seconds.
3. Add eggs and vanilla, then mix for 30-45 seconds.
4. Add flour and baking soda, then mix for 30-45 seconds.
5. Using the drop method, drop batter onto sheet pan in 30-gram
increments.
6. Place sheet pan in the oven and bake for 7-9 minutes.
7. Remove sheet pan from oven, then transfer cookies to cooling rack and
cool for 2-3 minutes.

This recipe is the same as that shown for standard chocolate chip cookies, replacing sucrose with an equal amount of the nonnutritive sweetener composition. Cookies made using this recipe are shown in FIG. 2.

Commercially Available Low-calorie Baking Blend Chocolate Chip Cookie Recipe

| Ingredients | Weight/measure | |
|---|---|---|
| Unsalted butter | 75 | grams |
| Splenda ® Zero Calorie | 90 | grams |
| Sweetener baking blend | | |
| Brown sugar | 30 | grams |
| Salt | 2 | grams |
| Eggs | 45 | grams |
| Vanilla extract | 2.5 | grams |
| All purpose flour | 150 | grams |
| Baking soda | 2 | grams |
| Chocolate chips | 150 | grams |

Commercially Available Low-calorie Baking Blend Chocolate Chip Cookie Recipe Method of Production

Method

1. Scale ingredients, bring butter & eggs to room temperature, line a sheet
pan with parchment paper, and preheat oven to 375° F. (190.6° C.).
2. Cream together butter, sweetener, and salt in a tabletop mixer using a
paddle attachment for 60-90 seconds.
3. Add eggs and vanilla, then mix for 30-45 seconds.
4. Add flour and baking soda, then mix for 30-45 seconds.
5. Using the drop method, drop batter onto sheet pan in 30-gram
increments.
6. Place sheet pan in the oven and bake for 7-9 minutes.
7. Remove sheet pan from oven, then transfer cookies to cooling rack and
cool for 2-3 minutes.

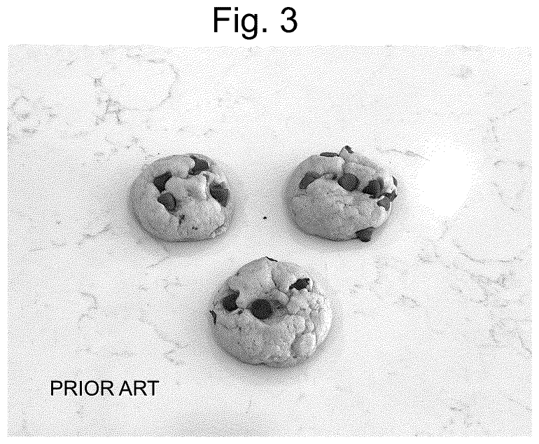

Cookies made using this recipe are shown in FIG. 3.

As can be seen in FIGS. 1-3, the cookies made with the nonnutritive sweetener composition have an appearance similar to that of the standard cookie recipe using sucrose. The commercially available low calorie cookies, on the other hand, have a distinctly different appearance. Both the sucrose and nonnutritive sweetener cookies, FIGS. 1 and 2, have a smooth surface and adhere to and coat the individual chocolate chips. In contrast, the commercially available low calorie cookies have a cracked surface and do not coat the chocolate chips. This demonstrates that the present invention more closely simulates the baking properties of sucrose than alternative low calorie products.

Blood glucose levels were monitored in individuals after consuming various amounts of the nonnutritive sweetener composition of the present invention. 5, 10 and 15 gram doses of the nonnutritive sweetener composition were administered to individuals, and their blood glucose levels were measured over the subsequent 2 hours. The results are shown in the table below:

| | Dose of Proposed Invention on Blood Glucose (mg/dL) | | |
|---|---|---|---|
| Minute | 5 grams | 10 grams | 15 grams |
| 0 | 72 | 79 | 68 |
| 15 | 72 | 83 | 74 |
| 30 | 74 | 84 | 81 |
| 60 | 72 | 78 | 76 |
| 120 | 70 | 76 | 76 |

As can be seen, blood glucose levels did not alter substantially for any of the three doses tested. Not surprisingly, the most significant rise in blood glucose levels occurred with the highest dosage. All groups showed a peak around 30 minutes after administering the dose, and leveled off after about 60 minutes.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. That is, the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. The descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A nonnutritive sweetener composition comprising:
37.58-56.37% erythritol;
37.54-56.31% allulose;
4.734-7.10% soluble fiber;
0.121%-0.182% stevia extract comprising diterpene glycosides;
0.015-0.023% sodium chloride; and,
0.009%-0.013% natural masking flavor.

2. A method of manufacturing a nonnutritive sweetener composition comprising:
mixing dry erythritol and a dry soluble fiber with an equal weight amount of water at or below room temperature;
mixing the erythritol, soluble fiber and water to form a liquid slurry mixture;
heating the liquid slurry mixture to between 85° and 98.5° C. and allowing the water to evaporate until the liquid slurry has a Brix between 90° Br and 96° Br;
discontinuing the addition of heat to the liquid slurry and adding an amount of dry allulose equal to the amount of dry erythritol;
continuing to mix the liquid slurry and allulose mixture until the water content is at or below 5% by weight, thereby forming a moist erythritol-allulose crystalline mixture;
compacting and granulating the erythritol-allulose crystalline mixture using an 18-35 mesh screen to form a granular erythritol-allulose crystalline mixture having granules sized from 0.5-1.0 mm;
mixing stevia leaf extract, salt and a masking flavoring using a reverse rotary agitator for 10 to 25 minutes at a speed of 5 to 15 rotations per minute to form a stevia mixture;
adding 20% of the granular erythritol-allulose crystalline mixture to the stevia mixture every 5 to 10 minutes while mixing in the reverse rotary agitator until the entire granular erythritol-allulose crystalline mixture has been added to form a uniform mixture;
using a dry powder roller compactor with a granulating oscillator to form the nonnutritive sweetener composition as a powder using an 18 to 35 mesh screen size;
drying the nonnutritive sweetener composition at a temperature below 55° C. until the moisture content of the composition is below 1%.

3. The method of manufacturing a nonnutritive sweetener composition of claim 2 wherein the composition comprises:
37.58-56.37% erythritol;
37.54-56.31% allulose;
4.734-7.10% soluble fiber;
0.121%-0.182% stevia extract comprising diterpene glycosides;
0.015-0.023% sodium chloride; and,
0.009%-0.013% natural masking flavor.

4. The method of manufacturing a nonnutritive sweetener composition of claim 3 wherein the soluble fiber is selected from soluble corn fiber and tapioca fiber.
